(19) United States
(12) Patent Application Publication
(10) Pub. No.: US 2006/0143634 A1
(43) Pub. Date: Jun. 29, 2006

(54) Plate for a drive for optical storage media

(76) Inventors: Gunter Tabor, Villingen-Schwenningen (DE); Reiner Baas, Steinach (DE); Rolf Dupper, Villingen-Schwenningen (DE)

Correspondence Address: THOMSON LICENSING INC., PATENT OPERATIONS, PO BOX 5312, PRINCETON, NJ, 08543-5312, US

(21) Appl. No.: 10/544,579

(22) PCT Filed: Jul. 12, 2003
(86) PCT No.: PCT/EP03/07563

§ 371 Date: Aug. 5, 2005

(30) Foreign Application Priority Data
Feb. 12, 2003 (DE) 103 05 951.2

(51) Int. Cl. G11B 33/08; G11B 33/14

(52) U.S. Cl. 720/651

(57) ABSTRACT

In drop tests, the optical scanner of a drive of this type falls at high speed against a mechanical stop. Said stop is located on a plate of the drive. The fall can cause mechanical damage to the optical scanner or an associated drive. According to the invention, part of the plate is configured in a sprung manner and acts as an elastic stop for the optical scanner.

The present invention relates to a board for a drive for optical storage media, and to an appliance for reading from and/or writing to optical storage media which has a board such as this.

Appliances for reading from and/or writing to optical storage media such as compact discs (CD) or digital versatile discs (DVD) use an optical scanner in order to read information from data tracks which are located on the optical storage medium and in order to store information on the storage medium. For this purpose, the optical scanner can be moved relative to the data tracks, with the movement of the optical scanner generally being at right angles to the tracks.

FIG. 8 shows a drive (6) of an appliance such as this for reading from and/or writing to optical storage media. The drive (6) has a board (1) on which a turntable (4) is fitted which is driven by a motor (5). The board (1) has a cutout in which an optical scanner (3) can be moved along an axis (A) essentially at right angles to the data tracks of an optical storage medium (not shown) which is located on the turntable (4).

When appliances for reading from and/or writing to optical storage media are being transported, it is possible for some of the appliances to be dropped on the ground. Drop tests are carried out in advance in order to determine whether the drive that is located in the appliance will withstand such impacts without being damaged. In a drop test such as this, the optical scanner is moved at high speed against a mechanical strop, generally against the edge of the cutout which is located in the board. This can lead to mechanical damage to the scanner or to an associated transmission. One object of the invention is to improve the prior art.

According to the invention, a part of the board is shaped like a spring and is used as a stop for the optical scanner. The flexible design of the board prevents damage to the drive or to the optical scanner in drop tests and in real impacts, since this results in a damped impact of the optical scanner even if the board material is hard. Furthermore, no additional parts are required, as in the case of the known solutions, which have to be installed in a separate step. This reduces the costs of the board. The invention is not restricted to drives with an optical scanner and can also be used for other drives with a moving scanner.

The spring-like part of the board is preferably located on the plane of the board. In this case, the spring-like design can be achieved by a simple stamping process. This allows the board to be produced at low cost.

In some circumstances, depending on the optical scanner that is used or on the space conditions on the board, it is advantageous to provide the spring-like part of the board outside the plane of the board. This is achieved, for example, by bending a web.

A board according to the invention is advantageously used in an appliance for reading from and/or writing to optical storage media. This results in an appliance such as this being less susceptible to transport damage.

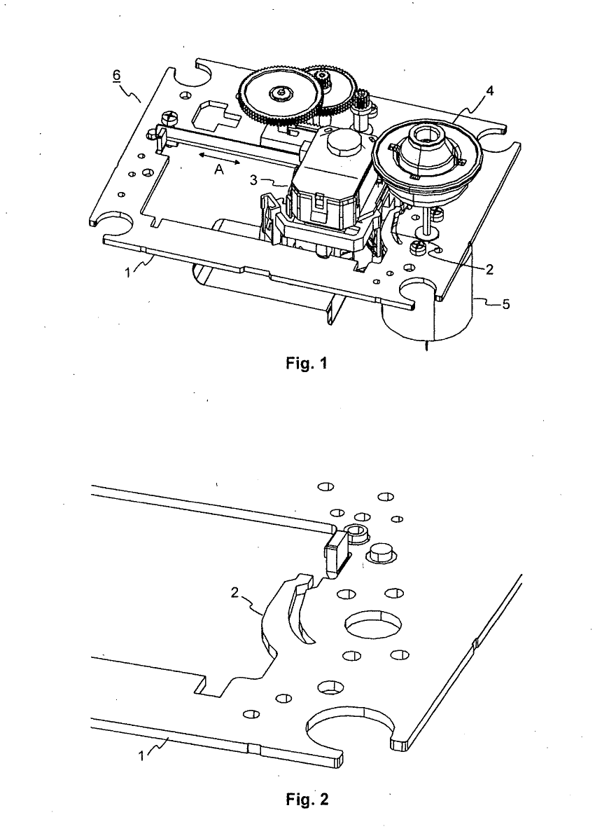

In order to assist understanding, the invention is illustrated in more detail in FIGS. 1 to 7. The invention is, of course, not restricted to the illustrated exemplary embodiments. In the figures:

FIG. 1 shows a board according to the invention in a drive for optical storage media,

FIG. 2 shows an exemplary embodiment of the invention, in which the spring-like part is located on the plane of the board,

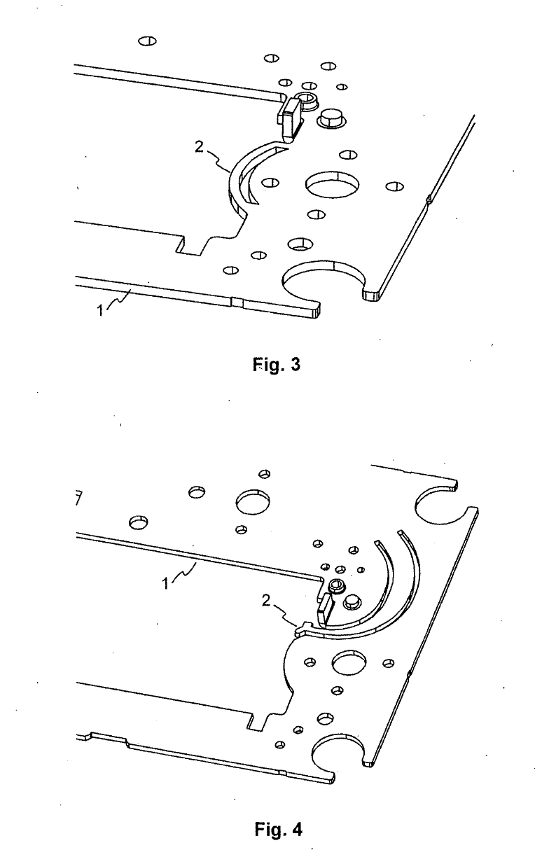

FIG. 3 shows a first variant of the exemplary embodiment shown in FIG. 2,

FIG. 4 shows a second variant of the exemplary embodiment shown in FIG. 2,

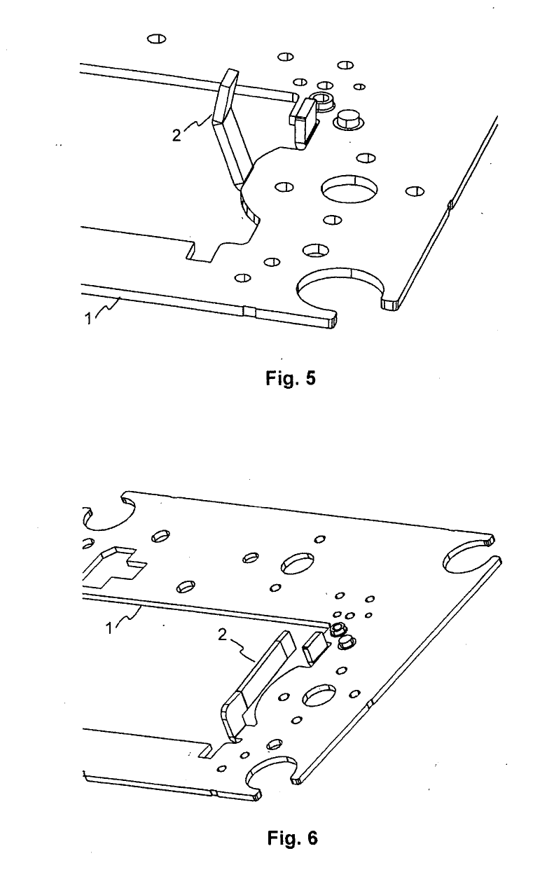

FIG. 5 shows an exemplary embodiment of the invention, in which the spring-like part is located outside the plane of the board,

FIG. 6 shows a first variant of the exemplary embodiment shown in FIG. 5,

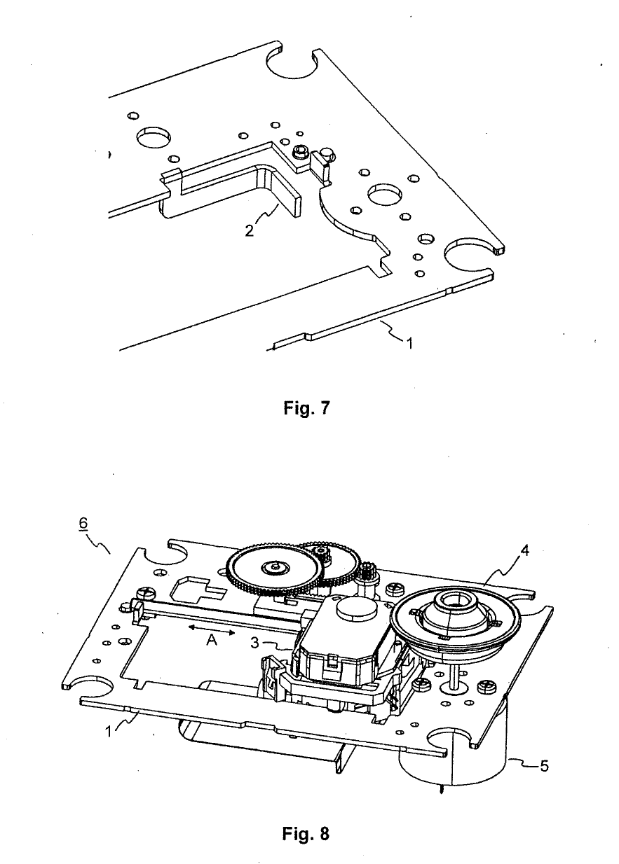

FIG. 7 shows a second variant of the exemplary embodiment shown in FIG. 5, and

FIG. 8 shows a board according to the prior art in a drive for optical storage media.

FIG. 1 shows a board (1) according to the invention in a drive (6) for optical storage media. During a drop test, the optical scanner (3) is moved at high speed against a spring-like, elastic part (2) of the board. The elastic part (1) is itself formed from the board. A damping effect on the optical scanner (3), which is moving at high speed, is achieved by partial deformation of the board (1) in the area of the spring-like part (2). The drop test requirements are satisfied without any additional parts. No flexible materials such as rubber or plastic are required.

The elastic part (2) causes the optical scanner (3) to spring back slightly. However, this has no disturbing influence, since the acceleration resulting from the springing-back process is less than the acceleration in the direction of the spring arm. According to one advantageous refinement, the spring arm has a spring movement of 0.3 mm. After a first drop test, a spring movement of 0.2 mm remains, since about 0.1 mm of the spring arm has been permanently deformed by a load of the material outside the elastic range. The function of the spring arm is thus maintained in a weaker form for further drop tests as well. The spring movement of 0.2 mm corresponds to the elastic range of the spring arm, and the spring movement is thus stable in the long term.

FIG. 2 shows one exemplary embodiment of the invention, in which the spring-like part (2) is located on the plane of the board (1). In this exemplary embodiment, the spring-like part (2) of the board (1) is in the form of a spring arm. The free, angled end of the spring arm is matched to the shape of the optical scanner (3) such that a flat contact is formed between the spring arm and the optical scanner (3) during the drop tests, rather than a line contact. A line contact stop surface could damage the optical scanner (3), since the pressure on the material becomes greater when the contact area is small. The shape of the spring arm is also designed such that material stresses which occur under load are distributed uniformly over the entire spring arm.

A first variant of the above exemplary embodiment is illustrated in FIG. 3. In this case, the spring-like part (2) of the board (1) is a leaf spring which is connected to the board (1) at both ends and is produced by stamping an appropriate cutout into the board (1). The embodiment as a leaf spring results in the same spring effect with a reduced material thickness. This variant is particularly advantageous for optical scanners (3) with a metal housing, because greater forces occur in drop tests, owing to the greater mass.

A second variant of the above exemplary embodiment is shown in FIG. 4. The spring-like part (2) of the board (1) is similar to that in FIG. 2, that is to say it is curved and is connected firmly to the board (1) on only one side. However, it is stamped out of a different area of the board (1) and has a considerably longer spring arm. This variant has the advantage that the material stresses are distributed better, owing to the long spring arm. In consequence, a drop test does not result in permanent deformation.

A further exemplary embodiment of the invention is shown in FIG. 5. The spring-like part (2) of the board (1) comprises a piece (2) of the board (1) which is bent to form a stop angle. The stop angle is in this case essentially at right angles to the board (1). This is an advantageous alternative, depending on the space conditions on the board (1) and/or overall in the drive (6). A configuration such as this is also worthwhile when the optical scanner (3) has an intended stop point which is outside the plane of the board (1). Production of the spring arm by bending a part (2) of the board (1) is more complex in terms of tooling, but the spring effect is comparable to that of a spring produced by stamping.

A first variant of the above exemplary embodiment is illustrated in FIG. 6. In this case as well, a piece (2) of the board (1) is bent to form a stop angle. However, the stop angle is designed such that the actual spring is located essentially parallel to the board (1). This variant is distinguished in that it projects considerably less out of the plane of the board (1), with a comparable spring effect of the spring-like part (2) of the board (1).

A second variant of the above exemplary embodiment is shown in FIG. 7. In this case, the piece (2) which is bent to form a stop angle originates from a different area of the board (1), which is not located in the movement direction (A) of the optical scanner (3). In this exemplary embodiment as well, the spring is located essentially parallel to the board (1). In order to achieve a spring effect, a part of the spring is angled such that it is located at right angles to the movement direction (A) of the optical scanner (3). This variant is advantageous, for example, when it is impossible for space reasons to stamp a spring-like part out of that region of the board (1) which is located in the movement direction (A) of the optical scanner (3).

Further solutions for prevention of damage provide for the use of flexible hooks made of plastic or rubber buffers, which act as flexible stoppers. Another measure is for a part of the board to be composed of a soft material.

1. A board for a drive for optical storage media having a spring-like element which is used as a stop for an optical scanner, wherein the spring-like element is a part of the board.

2. The board as claimed in claim 1, wherein the spring-like part of the board is located on the plane of the board.

3. The board as claimed in claim 1, wherein the spring-like part is stamped out of the board.

4. The board as claimed in claim 1, wherein the spring-like part of the board is located outside the plane of the board.

5. The board as claimed in claim 1, wherein the spring-like part is a piece of the board which is bent to form a stop angle.

6. An appliance for reading from and/or writing to optical storage media, wherein the appliance has a board as claimed in claim 1.
